(19) United States
(12) Patent Application Publication
(10) Pub. No.: US 2014/0237771 A1
(43) Pub. Date: Aug. 28, 2014

(54) GATE LIFTING APPARATUS

(71) Applicant: Jim Burns, Sparta, NC (US)

(72) Inventor: Jim Burns, Sparta, NC (US)

(73) Assignee: INTERNATIONAL PIPES & ACCESSORIES LLC, Sparta, NC (US)

(21) Appl. No.: 14/186,489

(22) Filed: Feb. 21, 2014

Related U.S. Application Data
(60) Provisional application No. 61/768,783, filed on Feb. 25, 2013.

(51) Int. Cl. E05D 3/02

(52) U.S. Cl. CPC E05D 3/02
USPC 16/386

(57) ABSTRACT

A gate lifting apparatus for retrofitting a sagging gate including a first cylindrical segment having a first diameter and a second cylindrical segment having a second diameter that is larger than the first diameter. The second cylindrical segment has a first end and a second end, wherein the first end of the second cylindrical segment abuts the first cylindrical segment. The second cylindrical segment is cylindrically hollow and the second end of the second segment exposes a cylindrical cavity formed by it being hollow. The cylindrical cavity of the second cylindrical segment is configured to form a mating engagement with typical a gate hinge pin such that the first cylindrical segment then operatively serves as the new pin in a gate hinge assembly to vertically raise the position of the pin and, thus, raise the gate.

### CROSS-REFERENCE

This application claims the benefit of U.S. Provisional Patent Application No. 61/768,783 filed Feb. 25, 2013, the disclosure of which is expressly incorporated herein by reference.

### FIELD OF THE INVENTION

The present invention is directed towards an apparatus for easily lifting a gate, such as a gate for a fence, without considerable time or expense.

### BACKGROUND OF THE INVENTION

As shown in FIG. 1, a typical gate 10 for a fence, such as a farm fence, is affixed to a gate strainer post 12 via one or more hinge assemblies 14, such as one hinge assembly 14 proximate the top of the gate 10 and another hinge assembly 14 proximate the bottom of the gate 10. As shown in FIG. 2, each hinge assembly 14 typically comprises a pin 16 that is affixed to the strainer post 12 and a corresponding latch 18 that is affixed to the gate 10. During installation, the gate 10 is vertically aligned with the strainer post 12 such that each latch 18 slides down onto the corresponding pin 16 for a mating engagement.

Over time, wear and tear from normal usage, and misuse from children swinging on the gate 10, for example, can cause the strainer post 12 to tilt and no longer stay in a completely vertical position. That causes the gate 10 to sag and drag on the ground when it is opened and closed. Typically, fixing this problem requires the arduous, expensive, and time-consuming processes of replacing the strainer post or removing and then realigning the components of the hinge assemblies 14.

### BRIEF SUMMARY OF THE INVENTION

The present invention is a gate lifting apparatus including a first cylindrical segment having a first diameter and a second cylindrical segment having a second diameter. The second cylindrical segment has a first end and a second end, wherein the first end of the second cylindrical segment abuts the first cylindrical segment. The second cylindrical segment is cylindrically hollow and the second end of the second segment exposes a cylindrical cavity formed by it being hollow. The cylindrical cavity of the second cylindrical segment is configured to form a mating engagement with a gate hinge pin.

The first diameter is smaller than the second diameter, and the diameter of the cylindrical cavity is substantially the same as the first diameter of the first cylindrical segment.

The first and second segments may be integrally formed together. The apparatus may be formed of steel.

### BRIEF DESCRIPTION OF THE DRAWINGS

The present invention will be further apparent from the following detailed description of the preferred embodiments of the invention, when taken together with the accompanying specification and the drawings, in which:

FIG. 1 is front view of a typical fence gate;

FIG. 2 is a perspective view of a typical gate hinge assembly;

FIGS. 3-4 are perspective views of a gate lifting apparatus in accordance with an embodiment of the present invention;

FIG. 5 is a cross-sectional view of the gate lifting apparatus of FIGS. 3-4; and

FIG. 6 is an enlarged front view of the gate lifting apparatus of FIGS. 3-4, as installed on the gate hinge assembly of FIG. 2 in accordance with the present invention.

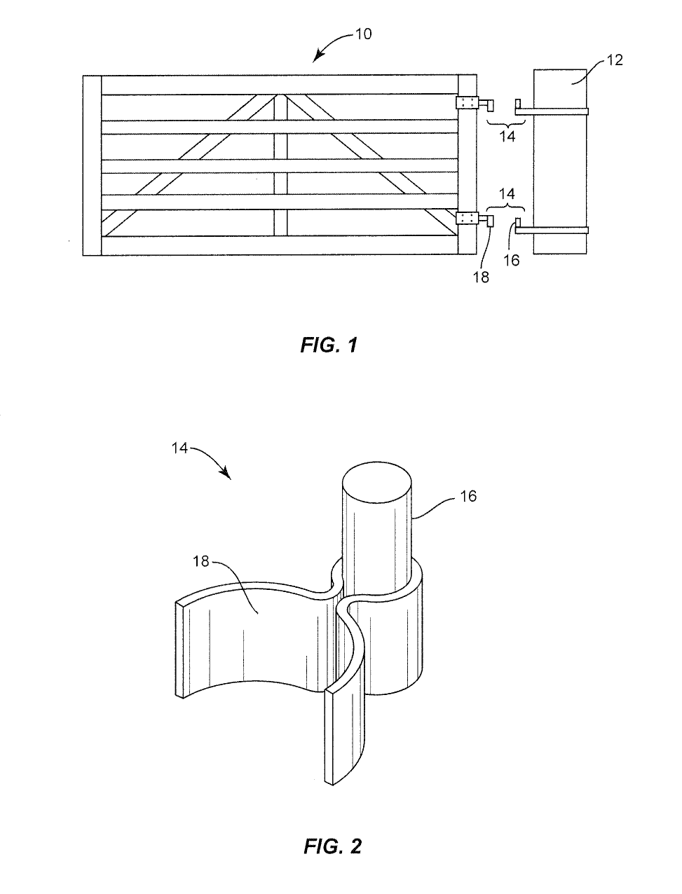

### DESCRIPTION OF THE PREFERRED EMBODIMENTS

The accompanying drawings and the description which follows set forth this invention in its preferred embodiments. However, it is contemplated that persons generally familiar with gates will be able to apply the novel characteristics of the structures illustrated and described herein in other contexts by modification of certain details. Accordingly, the drawings and description are not to be taken as restrictive on the scope of this invention, but are to be understood as broad and general teachings.

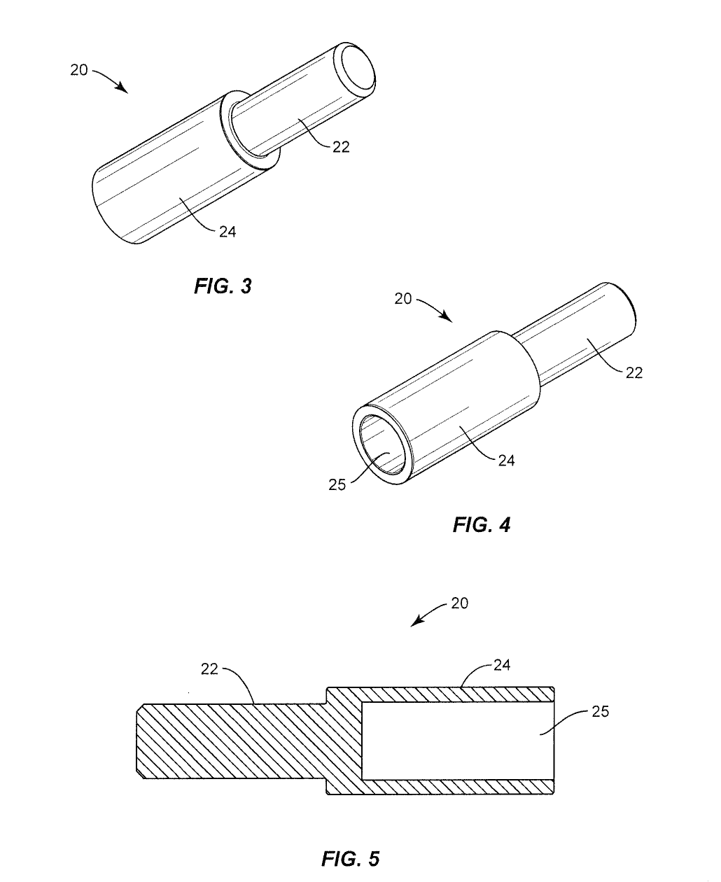

The gate lifting apparatus 20 of the present invention provides an inexpensive and easy retrofit to fix sagging gates 10. As shown in FIGS. 3-5, the gate lifting apparatus 20 generally comprises two cylindrically shaped segments that may be affixed to one another or integrally formed together. The first segment 22 is generally (and may be substantially) the same shape and size as the pin 16 of the hinge assembly 14. The second segment 24 has a wider diameter than the first segment 22 and includes a hollow cavity 25. The hollow cavity 25 is also substantially the same shape and size as the pin 16. The gate lifting apparatus 20 is preferably formed of heavy duty steel with a heave duty zinc coating to retain its durability.

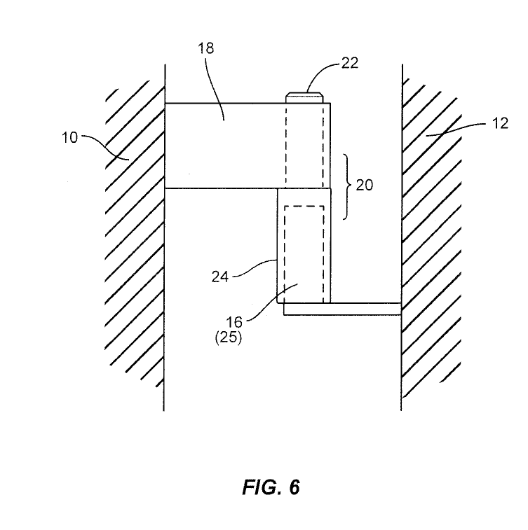

The gate lifting apparatus 20 is configured to be installed on existing hinge assemblies 14 in order to raise the gate 10 and keep it from sagging or dragging when the gate 10 is opened and closed. In order to install the gate lifting apparatus 20, the gate 10 is first removed by lifting the gate 10 to disengage the latches 18 from the corresponding pins 16 of the hinge assemblies 14. A gate lifting apparatus 20 is then placed on each pin 16 affixed to the strainer post 12. As shown in FIG. 6, the hollow cavity 25 of the second segment 24 fits over the pin 16 such that the first segment 22 extends upward in the general shape and size of the original pin 16. The gate 10 is then reaffixed to the strainer post 12 by sliding the gate's 10 latches 18 back down onto the upwardly extending first segments 22 of each gate lifting apparatus 20 to create a mating engagement (the first segments 22 thus operatively serve as the new pins for mating with the existing latches 18).

By installing the gate lifting apparatus 20 as described above on each of the gate's hinge assemblies 14, the gate 10 is vertically lifted by a distance equal to the length of the second segment 24 of the apparatus 20. In a preferred embodiment, the length of the second segment 24 of the apparatus 20 is about two inches such that when installed, the gate 10 is vertically lifted about two inches. In many cases, this distance is sufficient to lift the gate 10 up so that it no longer drags on the ground when opened and closed. It should be understood, however, that varying lengths may be suitable for the apparatus 20.

In summary, the present invention provides an easy and inexpensive retrofit for lifting a sagging gate and, unlike prior art fixes, installation of the present invention does not require any welding, drilling, digging or other time-consuming installation techniques.

While preferred embodiments of the invention have been described using specific terms, such description is for present illustrative purposes only, and it is to be understood that changes and variations to such embodiments, including but not limited to the substitution of equivalent features or parts, and the reversal of various features thereof, may be practiced by those of ordinary skill in the art without departing from the spirit or scope of the present disclosure.

What is claimed is:

1. A gate lifting apparatus comprising:
a first cylindrical segment having a first diameter; and
a second cylindrical segment having a second diameter;
the second cylindrical segment having a first end and a second end; and
the second cylindrical segment being cylindrically hollow;
wherein the first end of the second cylindrical segment abuts the first cylindrical segment;
wherein the second end of the second cylindrical segment exposes a cylindrical cavity formed by the second cylindrical segment being cylindrically hollow;
wherein the cylindrical cavity of the second cylindrical segment is configured to form a mating engagement with a gate hinge pin.

2. The gate lifting apparatus of claim 1 wherein when the cylindrical cavity of the second cylindrical segment is in a mating engagement with a gate hinge pin, the first cylindrical segment is configured for engagement with a gate hinge latch.

3. The gate lifting apparatus of claim 1 wherein the first diameter is smaller than the second diameter.

4. The gate lifting apparatus of claim 1 wherein a diameter of the cylindrical cavity is substantially the same as the first diameter.

5. The gate lifting apparatus of claim 1 wherein the apparatus is formed of steel.

6. The gate lifting apparatus of claim 1 wherein the first segment and second segment are integrally formed together.
